(19) United States
(12) Patent Application Publication
(10) Pub. No.: US 2019/0393825 A1
(43) Pub. Date: Dec. 26, 2019

(54) FAILURE DIAGNOSIS METHOD FOR INVERTER CIRCUIT

(71) Applicant: Nidec Elesys Corporation, Kawasaki-shi (JP)

(72) Inventors: Osamu MAESHIMA, Kawasaki-shi (JP); Hajime NAKANE, Kawasaki-shi (JP); Junichi KONNO, Kawasaki-shi (JP); Takuya YOKOZUKA, Kawasaki-shi (JP); Shunjiro OSANAI, Kawasaki-shi (JP); Takafumi UMEMOTO, Kawasaki-shi (JP)

(21) Appl. No.: 16/435,620

(22) Filed: Jun. 10, 2019

(30) Foreign Application Priority Data
Jun. 21, 2018 (JP) 2018-118016

(51) Int. Cl. H02P 29/024; H02M 7/5387; H02P 27/08; B62D 5/04

(52) U.S. Cl. CPC H02P 29/024; B62D 5/0481; H02P 27/08; H02M 7/53871

(57) ABSTRACT

A failure diagnosis method for an inverter circuit, which easily performs failure diagnosis of a FET of the inverter circuit without delay includes comparing a motor terminal voltage corresponding to each phase of the inverter circuit including semiconductor switching devices (FETs) to drive a motor, with a threshold voltage by comparators as voltage comparison circuitry. At this time, the threshold voltage is changed according to a high-side FET and a low-side FET on which failure diagnosis is to be performed. Subsequently, by a digital output from the comparator, whether there is a short circuit of each FET of the motor terminal voltage is determined.

### CROSS REFERENCE TO RELATED APPLICATION

The present application claims priority under 35 U.S.C. § 119 to Japanese Application No. 2018-118016 filed on Jun. 21, 2018, the entire contents of which are incorporated herein by reference.

### FIELD OF THE INVENTION

The present disclosure relates to a failure diagnosis method for an inverter circuit included in, for example, a motor controller of an electric power steering apparatus.

### BACKGROUND

An electric motor that generates an auxiliary torque for a steering wheel operation by a driver of a vehicle such as an automobile and an electric power steering apparatus including a control apparatus and the like of the electric motor are constantly operating. Therefore, when any failure occurs in parts constituting a motor driving portion while driving, control for stopping the assistance operation for a steering wheel, for example, and identification of the failure parts are needed.

Hitherto, as a FET failure diagnosis method for an inverter circuit of the electric power steering apparatus, a method for monitoring a terminal voltage between a high-side FET and a low-side FET included in the inverter circuit with use of an A/D conversion function of a CPU has been known. In this method, when the inverter circuit is a three-phase bridge circuit, three signals (terminal voltages) of a U-phase, a V-phase, and a W-phase are monitored.

For example, the motor control apparatus disclosed in Japanese Patent No. 5181579 detects an overcurrent (short-circuit failure) in a motor driving circuit by an overcurrent detector and determines whether there is a failure in the motor driving circuit and the like from a result obtained by comparing each of terminal voltages VA, VB, VC of phase drive coils detected by motor terminal voltage detection means connected to relays connected in series to each phase output of the motor driving circuit and each terminal of each phase of a three-phase motor with a threshold value.

In Japanese Patent No. 5077030, as a method for determining motor abnormality, for example, a configuration is disclosed in which, in a case of U-phase FET failure diagnosis, U-phase motor terminal voltage is compared by a comparator after driving a V-phase or W-phase FET and a determination circuit determines whether there is a winding abnormality based on a comparison result.

In a voltage monitoring method using the A/D conversion function of the CPU described above, it has been pointed out that a voltage response delay by a filter circuit provided to remove switching noise superimposed on the motor terminal voltage, a delay due to an A/D sampling time, and a delay due to the CPU performing diagnostic processing a plurality of times to prevent recognition voltage error judgment for the purpose of coping with influence of the sampling delay and the like are occurred.

When the failure diagnosis of FETs of a bridge circuit is performed by monitoring each motor terminal voltage of the three-phase motor by the A/D conversion function of the CPU, a mounting area on a substrate occupied by parts for connecting the motor terminal voltages for the three phases to the CPU, a circuit pattern and the like, and a processing time necessary for the failure diagnosis have been problems in terms of downsizing and cost reduction of the motor control apparatus.

In Japanese Patent No. 5181579, not only the motor terminal voltage detection means but also the overcurrent detector for short-circuit failure determination of the FET in the motor driving circuit is provided, and hence a configuration for the failure determination becomes complicated. Further, the comparison between a value based on the terminal voltage and a predetermined threshold value is repeatedly performed a predetermined number of times and it is determined that there is a failure in the motor driving circuit when the number of times in which the value based on the terminal voltage exceeds the threshold value is equal to or lower than a predetermined value. Therefore, there is a problem in that a determination period is lengthened, and also in that it only identifies whether a failure section is in the motor or the motor driving circuit and cannot individually identify a failed FET included in the motor driving circuit.

In the abnormality determination in Japanese Patent No. 5077030, in addition to a configuration in which a drive pulse generation circuit for the abnormality determination is additionally provided as well as a normal FET control circuit and the drive pulse generation circuit is operated at a time of the diagnosis, control for initializing a charge of a capacitor is required. Thus, the configuration for the abnormality determination becomes complicated.

### SUMMARY

Example embodiments of the present disclosure provide failure diagnosis methods for inverter circuits, each of which easily perform failure diagnosis of a FET of the inverter circuit and identification of a failed FET without delay.

A first example embodiment of the present disclosure is a failure diagnosis method for an inverter circuit including a plurality of high-potential-side driving devices and a plurality of low-potential-side driving devices, the method including setting a reference voltage in voltage comparison circuitry, driving each of the high-potential-side driving devices and each of the low-potential-side driving devices, acquiring a comparison result between a voltage at a connection point of each of the high-potential-side driving devices and each of the low-potential-side driving devices after the driving and the reference voltage from the voltage comparison circuitry, and determining whether there is a failure in each of the high-potential-side driving devices and each of the low-potential-side driving devices based on the comparison result.

A second example preferred embodiment of the present disclosure provides a circuit board that performs failure diagnosis of a high-potential-side driving device and a low-potential-side driving device including an inverter circuit, the circuit board including voltage comparison circuitry to compare a voltage to be measured from the inverter circuit and a reference voltage, and determiner to determine whether there is a failure in the high-potential-side driving device and the low-potential-side driving device based on an output from the voltage comparison circuitry by the failure diagnosis method for an inverter circuit according to the first example embodiment of the present disclosure.

A third example embodiment of the present application provides a motor control apparatus including an inverter circuit that drives a motor, the motor control apparatus including voltage comparison circuitry to compare a voltage to be measured from the inverter circuit and a reference voltage, and a determiner to determine whether there is a failure in a high-potential-side power device and a low-potential-side power device of the inverter circuit based on an output from the voltage comparison circuitry by the failure diagnosis method for an inverter circuit according to the first example embodiment of the present disclosure.

A fourth example embodiment of the present disclosure provides a motor control apparatus used in electric power steering to assist a steering wheel operation of a driver of a vehicle, the motor control apparatus including an inverter circuit to drive a motor, voltage comparison circuitry to compare a voltage to be measured from the inverter circuit and a reference voltage, and a determiner to determine whether there is a failure in a high-potential-side power device and a low-potential-side power device of the inverter circuit based on an output from the voltage comparison circuitry by the failure diagnosis method for an inverter circuit according to the first example embodiment of the present disclosure.

A fifth example embodiment of the present disclosure provides an electric power steering system including the motor control apparatus used in electric power steering according to the fourth example embodiment of the present disclosure.

According to example embodiments of the present disclosure, voltage comparison circuitry compares the voltage at the connection point of the high-potential-side driving device and the low-potential-side driving device of the inverter circuit with the reference voltage, and determines whether there is a failure in the driving device based on a digital output value from the voltage comparison circuitry. Thus, since there is no signal response delay at a time of the failure diagnosis and waiting time for avoiding erroneous determination becomes unnecessary, whether there is a failure is diagnosed quickly.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a schematic configuration of an electric power steering apparatus on which an electronic control unit (motor driving control unit) according to an example embodiment of the present disclosure is mounted.

FIG. 2 is a block diagram illustrating an entire configuration of an electronic control unit according to an example embodiment of the present disclosure.

FIG. 3 is a flowchart illustrating a failure diagnosis processing procedure of an inverter circuit in a controller of the electronic control unit illustrated in FIG. 2.

FIG. 4 is a reference chart in which a failure diagnosis mode, a signal for the failure diagnosis, a threshold setting, a failure pattern (failure state), and the like in the failure diagnosis processing are combined.

FIG. 5 is a flowchart illustrating an example of processing additionally performed after the FET failure diagnosis in FIG. 4.

FIG. 6 is a block diagram illustrating an entire configuration of an electronic control unit according to a modified example.

### DETAILED DESCRIPTION

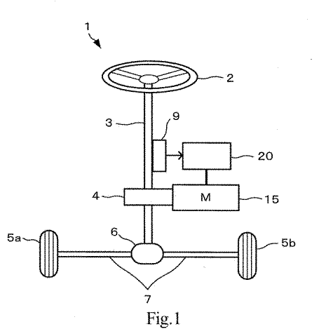

Example embodiments according to the present disclosure are described in detail below with reference to the accompanying drawings. FIG. 1 is a schematic configuration of an electric power steering apparatus on which an electronic control unit (motor driving control unit) according to the example embodiment of the present disclosure is mounted. An electric power steering apparatus 1 in FIG. 1 includes an electronic control unit (ECU) 20, a steering wheel 2 that is a steering member, a rotating shaft 3 connected to the steering wheel 2, a pinion gear 6, a rack shaft 7, and the like.

The rotating shaft 3 is engaged with the pinion gear 6 provided at a distal end thereof. By the pinion gear 6, a rotational motion of the rotating shaft 3 is converted to linear motion of the rack shaft 7 and a pair of wheels 5a and 5b provided at both ends of the rack shaft 7 is steered at an angle corresponding to an amount of displacement of the rack shaft 7.

A torque sensor 9 detecting steering torque when the steering wheel 2 is operated is provided on the rotating shaft 3, and the detected steering torque is transmitted to the electronic control unit 20. The electronic control unit 20 generates a motor driving signal based on signals of the steering torque acquired by the torque sensor 9, and a vehicle speed and the like from a vehicle speed sensor (not shown), and outputs the signal to an electric motor 15.

An auxiliary torque for assisting steering of the steering wheel 2 is output from the electric motor 15 to which the motor driving signal is input, and the auxiliary torque is transmitted to the rotating shaft 3 via a speed reduction gear 4. As a result, the steering wheel operation of a driver is assisted by assisting the rotation of the rotating shaft 3 by the torque generated in the electric motor 15.

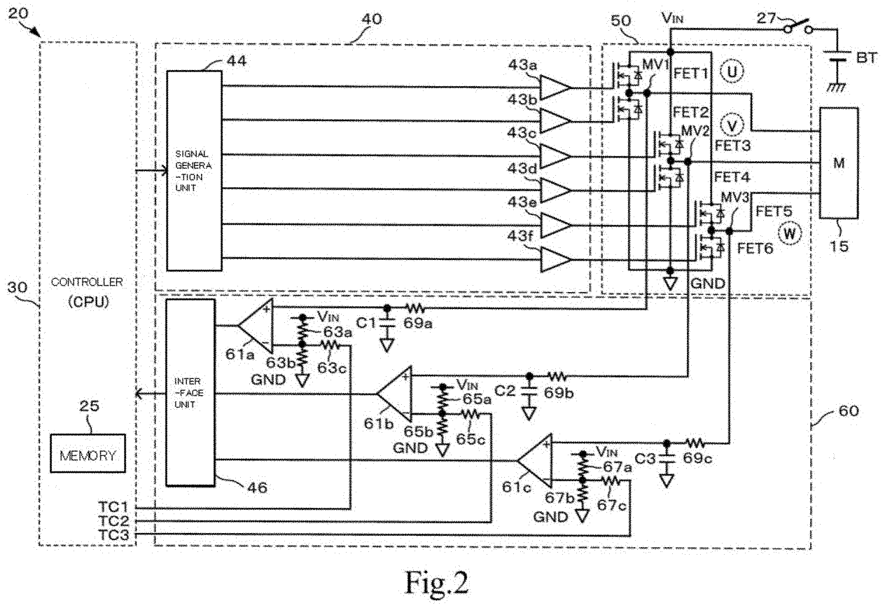

FIG. 2 is a block diagram illustrating an entire configuration of the electronic control unit according to the example embodiment of the present disclosure. A configuration in which the electronic control unit serving as the motor driving control unit is mounted on the electric power steering apparatus is described below as an example.

As illustrated in FIG. 2, the electronic control unit 20 includes a controller (CPU) 30 that is responsible for control of the entire electronic control unit 20, a pre-driver unit 40 that generates a motor driving signal by a control signal from the controller 30 and functions as a FET drive circuit, a motor driving portion 50 serving as an inverter circuit (motor driving circuit) that supplies a predetermined drive current to the electric motor 15, an MV terminal voltage monitoring unit 60 that monitors a voltage of each motor terminal (also referred to as MV terminal) corresponding to each phase of the electric motor 15, and the like.

The controller 30 includes a microprocessor, for example, and a calculation value and the like necessary for the execution of failure diagnosis processing is temporarily stored in a memory 25 in addition to a procedure (processing program) of the failure diagnosis processing described below that is executed by the controller 30.

A power supply for driving the motor is supplied to the motor driving portion 50 by an external battery BT via a power supply relay 27. The power supply relay 27 can be formed so as to be able to cut off the power from the battery BT, and can include a semiconductor relay. The motor driving portion 50 is a FET bridge circuit including a plurality of semiconductor switching devices (a FET1 to a FET6).

Each of the FETs 1, 3, and 5 in the FET1 to the FET6 has a drain terminal connected to the power supply side. In addition, the FETs 1, 3, and 5 each have a source terminal connected to respective drain terminals of the FETs 2, 4, and 6, and the FETs 2, 4, and 6 have a source terminal connected to a ground (GND) side.

The controller 30 outputs a pulse width modulation (PWM) signal based on the signals of the steering torque and from the vehicle speed sensor and the like to the pre-driver unit 40. A signal generation unit 44 of the pre-driver unit 40 generates an ON/OFF control signal for the semiconductor switching devices of the motor driving portion 50 by increasing and reducing a duty of a PWM control signal in accordance with the PWM signal from the controller 30, for example.

The electric motor 15 is, for example, a three-phase brushless DC motor, and the above-described FET bridge circuit is an inverter circuit of three phases (U-phase, V-phase, W-phase). The semiconductor switching devices (the FET1 to the FET6) constituting the inverter circuit correspond to the respective phases of the electric motor 15. Here, the FETs 1 and 2 correspond to the U-phase, the FETs 3 and 4 correspond to the V-phase, and the FETs 5 and 6 correspond to the W-phase.

Out of those FETs, the FETs 1, 3, and 5 are upper-arm (also referred to as high-side (HiSide)) switching devices in the U-phase, the V-phase, and the W-phase, respectively, and the FETs 2, 4, and 6 are lower-arm (also referred to as low-side (LoSide)) switching devices in the U-phase, the V-phase, and the W-phase, respectively. The switching devices (FETs) are also referred to as power devices. Metal-oxide semiconductor field-effect transistors (MOSFET) are included herein. In addition, switching devices such as insulated gate bipolar transistor (IGBT) may also be used.

The pre-driver unit 40 is an integrated circuit for controlling the motor (pre-driver IC). In the pre-driver unit 40, drivers (pre-drivers) 43a to 43f that drive the semiconductor switching devices (the FET1 to the FET6), and the like are integrated. The drivers 43a, 43c, and 43e drive the high-side (HiSide) FETs 1, 3, and 5 of the motor driving portion (inverter circuit) 50, respectively, and the drivers 43b, 43d, and 43f drive the low-side (LoSide) FETs 2, 4, and 6 of the motor driving portion 50, respectively.

The MV terminal voltage monitoring unit 60 includes three voltage comparison circuits (comparators) 61a to 61c that monitor an MV terminal voltage of each phase of the electric motor 15. Specifically, the voltage of the U-phase MV terminal (MV1) is monitored by the comparator 61a, the voltage of the V-phase MV terminal (MV2) is monitored by the comparator 61b, and the voltage of the W-phase MV terminal (MV3) is monitored by the comparator 61c.

The terminal voltages of the MV terminals MV1 to MV3 are input to non-inverting input terminals (+) of the comparators 61a to 61c, respectively. Filters (low pass filters) composed of resistors 69a to 69c and capacitors C1 to C3, respectively, are provided on signal lines between the non-inverting input terminals (+) and the MV terminals MV1 to MV3 respectively to remove high frequency noise.

Each of inverting input terminals (−) of the comparators 61a to 61c is connected to a plurality of resistors (hereinafter, a configuration including these resistors is referred to as a threshold voltage generation unit) to generate a threshold voltage. As shown in FIG. 2, the threshold voltage generation units are composed of respective resistors 63a, 63b, 65a, 65b, 67a, and 67b that are connected in series between an inverter power supply voltage and the ground (GND) and whose connection points are connected to the inverting input terminals (−) respectively, and resistors 63c, 65c, and 67c whose one ends are connected to the connection points of the resistors 63a, 63b, 65a, 65b, 67a, and 67b and into which threshold control signals from the controller 30 are input at the other ends respectively.

The comparators 61a to 61c compare voltage levels of the terminal voltages of the MV terminals MV1 to MV3 input into the non-inverting input terminals (+) with the threshold voltage, respectively, and output the results as logical value signals (logic Hi or logic Lo).

The threshold control signals output from output terminals TC1 to TC3 of the controller 30 to the threshold voltage generation units of the comparators 61a to 61c are signals for changing the respective threshold voltages (reference voltages applied to the inverting input terminals (−)) of the comparators 61a to 61c according to ON/OFF control of the high-side (HiSide) switching devices and the low-side (LoSide) switching devices of the respective phases.

A variable mechanism of the reference voltage will be described by taking the comparator 61a as an example hereinafter. For example, in the resistors 63a and 63c whose one ends are connected to each other, when a signal of the logic Hi is input from the output terminal TC1 to the other end of the resistor 63c, the resistor 63a of which the other end is connected to the inverter power supply and the resistor 63c of which the other end is at a potential of the logic Hi are connected in parallel.

As a result, a parallel connection resistor of the resistors 63a and 63c and the resistor 63b on the GND side are connected in series via the connection point to the inverting input terminal (−). Since the resistor 63a is connected in parallel to the resistor 63c and a combined resistance value is reduced, a potential at the connection point to the resistor 63b (a reference potential to the inverting input terminal (−)) increases according to a ratio of a combined resistance value of the parallel connection resistor and a resistance value of the resistor 63b as compared to a potential when, for example, the output terminal TC1 is in a high impedance state and no logical value output is output from the output terminal TC1.

On the other hand, when a signal of the logic Lo is output from the output terminal TC1, in the resistors 63b and 63c whose one ends are connected to each other, the resistor 63b of which the other end is connected to the GND and the resistor 63c of which the other end is at a potential of the logic Lo are connected in parallel. As a result, the combined resistance value of the resistor 63b that is connected in parallel to the resistor 63c is reduced, the potential at the connection point to the resistor 63a (the reference potential to the inverting input terminal (−)) is reduced according to a ratio of a combined resistance value of the parallel connection resistor and a resistance value of the resistor 63a as compared to the potential when the output terminal TC1 is in the high impedance state and no logical value output is output from the output terminal TC1.

As described above, the MV terminal voltage monitoring unit 60 has a function of changing the reference voltage (threshold voltage) for detecting the MV terminal voltage into the two states, and inputs the outputs from the comparators 61a to 61c into the controller 30 via an interface unit 46. The controller 30 detects a failure state in the FET based on the digital outputs (logic Hi or logic Lo) from the comparators 61a to 61c when each FET is individually turned ON/OFF at a time of failure diagnosis.

Next, a failure diagnosis method of the motor driving circuit (inverter circuit) in the electronic control unit according to this example embodiment is described.

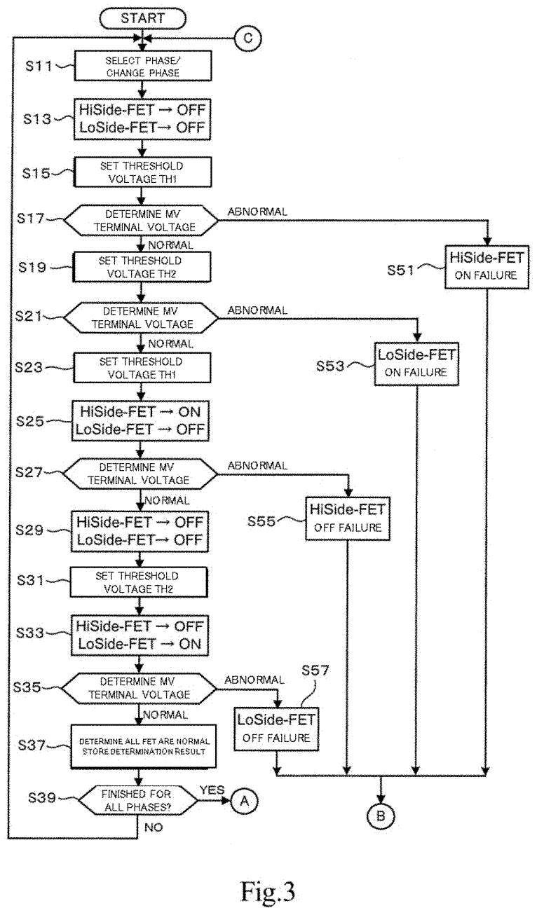

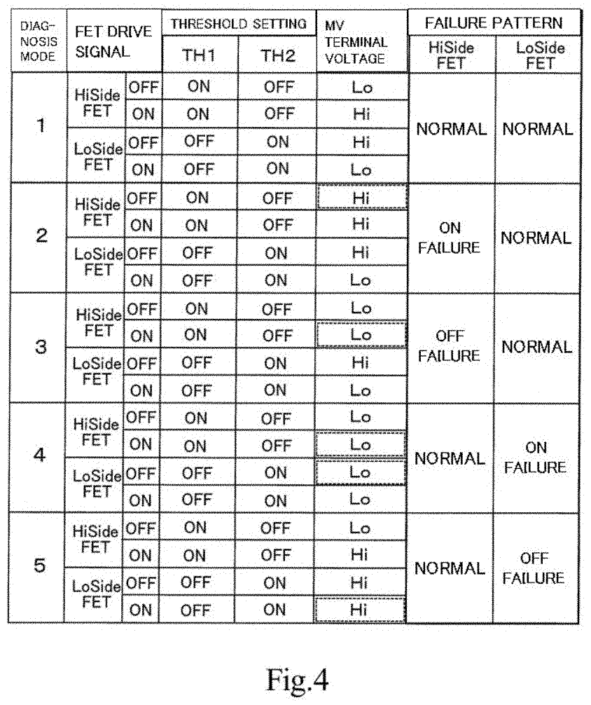

FIG. 3 is a flowchart illustrating a failure diagnosis processing procedure of the inverter circuit in the controller 30 of the electronic control unit 20 illustrated in FIG. 2. FIG. 4 is a reference chart in which a failure diagnosis mode, a signal for the failure diagnosis, a threshold setting, a failure pattern (failure state), and the like in the failure diagnosis processing in FIG. 3 are combined. The combination shown in FIG. 4 is common to the U-phase, the V-phase, and the W-phase.

In the failure diagnosis processing in the electronic control unit according to this example embodiment, the controller 30 sets a threshold voltage TH1 as a detection threshold of the MV terminal voltage at the time of the failure diagnosis in the HiSide-FET, and sets a threshold voltage TH2 at the time of the failure diagnosis in the LoSide-FET. Subsequently, the high-side (HiSide) FET and the low-side (LoSide) FET of each of the U-phase, V-phase, and W-phase that constitute the bridge circuit are driven (ON/OFF) in order, and the controller 30 determines whether the MV terminal voltage is a normal value or an abnormal value.

When the FET is driven, the FET is brought into an ON state when the drain current flows with application of a voltage that is sufficiently higher than a gate threshold voltage (a gate-to-source voltage at which the drain current starts to flow) to a place across the gate and the source. Therefore, when a voltage equal to or lower than the gate threshold voltage is applied to a place across the gate and the source, the FET is in an OFF state.

It should be noted that the state in which a “FET drive signal” is “OFF” in FIG. 4 means a state in which the failure diagnosis is not performed (a diagnosis function is OFF).

In a first step (step S11 of FIG. 3) of the failure diagnosis processing of the FET, the controller 30 selects a phase of bridge circuit FET on which the failure diagnosis is to be performed out of the U-phase, the V-phase, and the W-phase. For example, when the U-phase is selected, the controller 30 transmits OFF signals to the drivers 43a and 43b via the signal generation unit 44 of the pre-driver unit 40 in step S13.

Thus, the drivers 43a and 43b apply voltages equal to or lower than the gate threshold voltage to gate terminals of the U-phase high-side (HiSide) switching device (FET1) and the U-phase low-side (LoSide) switching device (FET2) respectively to de-energize the FETs 1 and 2 (OFF).

In subsequent step S15, the controller 30 turns on the output terminal TC1 in order to detect whether there is a failure in the high-side FET1, and outputs a signal of the logic Hi to the threshold voltage generation unit of the comparator 61a. Thereby, the threshold voltage TH1 is set to the inverting input terminal (−) of the comparator 61a.

Here, the resistance values of the resistors 63a to 63c are determined such that, as the threshold voltage TH1, a potential higher than an intermediate value of the voltage between the inverter power supply voltage V_{IN} and the ground (GND), for example, (½)V_{IN}<TH1, is set.

In step S17, the controller 30 monitors and determines whether there is an abnormality in the voltage of the U-phase MV terminal (MV1) based on an output value (logic level) of the comparator 61a. As shown in FIG. 4, in a normal state, when the high-side FET1 is in the OFF state and the threshold voltage TH1 is set, the voltage of the MV terminal (MV1) becomes the logic Lo. Therefore, when the controller 30 controls the FETs 1 and 2 to the OFF state and sets the threshold voltage TH1, in a case in which the output of the comparator 61a is the logic Lo, the voltage of the MV terminal (MV1) is lower than the threshold voltage TH1. Thus, the controller 30 determines that a normal value is shown.

On the other hand, when the output of the comparator 61a is the logic Hi, the voltage of the MV terminal (MV1) that should be normally the logic Lo is higher than the threshold voltage TH1. Thus, the controller 30 determines that the high-side FET1 is abnormal (ON failure) (step S51).

In subsequent step S19, the controller 30 turns off the output terminal TC1 in order to detect whether there is a failure in the low-side FET2. As a result, a signal of the logic Lo is output to the threshold voltage generation unit of the comparator 61a, and the threshold voltage TH2 is set to the inverting input terminal (−) of the comparator 61a.

As the threshold voltage TH2, a potential equal to or lower than the intermediate value of the voltage between the inverter power supply voltage and the ground (GND), for example, (½)V_{IN}≥TH2 is set.

As shown in FIG. 4, when the threshold voltage TH2 is set and the low-side FET2 is in the OFF state, in the normal state, the voltage of the MV terminal (MV1) becomes the logic Hi. When the threshold voltage TH2 is set and the FETs 1 and 2 are both controlled to be in the OFF state, in a case in which the controller 30 detects the logic Hi as the output of the comparator 61a in step S21, the controller 30 determines that the voltage of the MV terminal (MV1) is higher than the threshold voltage TH1 and the normal value is shown.

On the other hand, when the output of the comparator 61a is the logic Lo, the voltage of the MV terminal (MV1) that should be normally the logic Hi is lower than the threshold voltage TH2. In this case, the controller 30 determines that the low-side FET2 is abnormal (ON failure) (step S53).

In subsequent step S23, the controller 30 sets the threshold voltage TH1 and, in step S25, energizes the high-side FET1 (ON) and de-energizes the low-side FET2 (OFF). In this case, in the normal state without the failure, the voltage of the MV terminal (MV1) becomes the logic Hi as shown in FIG. 4. Thus, in step S27, when the output of the comparator 61a is the logic Hi, the controller 30 determines that the voltage of the MV terminal (MV1) is higher than the threshold voltage TH1 and is the normal value.

On the other hand, when the output of the comparator 61a is the logic Lo, since the voltage of the MV terminal (MV1) that should be normally the logic Hi is lower than the threshold voltage TH1, the controller 30 determines that the high-side FET1 is abnormal (OFF failure) (step S55).

In step S29, the controller 30 controls both the FETs 1 and 2 to the OFF state. This is an initialization (reset) process for eliminating previous influence of control states of the FETs 1 and 2 in subsequent MV terminal voltage detection processing. This means that in the failure diagnosis processing in the electronic control unit according to this example embodiment, the failure diagnosis is started after the FETs 1 and 2 to be detected are confirmed to be in the OFF state.

In subsequent step S31, the controller 30 turns off the output terminal TC1 in order to detect whether there is a failure in the low-side FET2, and outputs the signal of the logic Lo to the threshold voltage generation unit of the comparator 61a. Thus, the threshold voltage TH2 is set to the inverting input terminal (−) of the comparator 61a.

In subsequent step S33, the controller 30 de-energizes the high-side FET1 (OFF) and energies the low-side FET2 (ON). As shown in FIG. 4, in the normal state, when the threshold voltage TH2 is set and the low-side FET2 is in the ON state, the voltage of the MV terminal (MV1) becomes the logic Lo. When the output of the comparator 61a is the logic Lo as a result of monitoring in step S35, the controller 30 determines that the voltage of the MV terminal (MV1) is lower than the threshold voltage TH2 and is the normal value.

On the other hand, in step S35, when the output of the comparator 61a is the logic Hi, since the voltage of the MV terminal (MV1) that should be normally the logic Lo is higher than the threshold voltage TH2, the controller 30 determines that the low-side FET2 is abnormal (OFF failure) (step S57).

When the voltage of the U-phase MV terminal (MV1) corresponding to the ON/OFF control of the FETs 1 and 2 indicates the normal value by the above diagnosis processing, the controller 30 determines that the FETs 1 and 2 are neither the ON failure nor the OFF failure and determines that both are in the normal state, and a determination result is stored in the memory 25 in step S37.

In step S39, the controller 30 determines whether the above failure diagnosis has been finished for all the phases, that is, the U-phase, the V-phase, and the W-phase. When the failure diagnosis has not been finished for all the phases, the processing is returned to step S11 and the phase of the FET on which the failure diagnosis is to be performed is changed.

That is, the diagnosis processing of steps S11 to S37 above is performed for the V-phase, and the voltage of the MV terminal (MV2) at a time of ON/OFF control of the high-side FET3 and the low-side FET4 of the V-phase is monitored. Similarly, the diagnosis processing of steps S11 to S37 above is performed for also the W-phase, and the voltage of the MV terminal (MV3) at a time of ON/OFF control of the high-side FET5 and the low-side FET6 of the W-phase is monitored.

The state in which the high-side FET is determined to be abnormal (ON failure) in step S51 corresponds to a failure pattern (fault pattern) of “HiSide FET: ON failure, LoSide FET: normal” in “Diagnosis mode 2” of FIG. 4. The determination in step S53 in which the low-side FET is abnormal (ON failure) corresponds to a failure pattern (fault pattern) of “HiSide FET: normal, LoSide FET: ON failure” in “Diagnosis mode 4” of FIG. 4.

Similarly, the determination in step S55 in which the high-side FET is abnormal (OFF failure) corresponds to a failure pattern (fault pattern) of “HiSide FET: OFF failure, LoSide FET: normal” in “Diagnosis mode 3” of FIG. 4, and the determination in step S57 in which the low-side FET is abnormal (OFF failure) corresponds to a failure pattern (fault pattern) of “HiSide FET: normal, LoSide FET: OFF failure” in “diagnosis mode 5” of FIG. 4.

When it is determined that one of the high-side FET and the low-side FET is in an ON failure state (diagnosis modes 2 and 4 in FIG. 4), the other FET is driven by an ON signal and a through current (short circuit current) flows. Thus, in the failure diagnosis processing in the electronic control unit according to this example embodiment, such a diagnosis state is avoided.

As described above, by performing the diagnosis processing of steps S11 to S37 above for each of the U-phase, the V-phase, and the W-phase, the failure states and the failure portions of the high-side FET and the low-side FET corresponding to each phase can be identified.

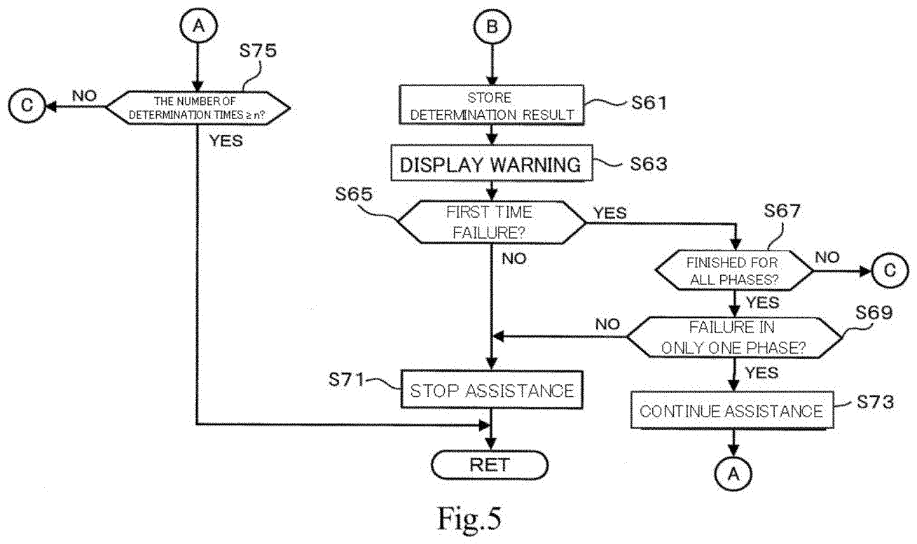

When the electronic control unit according to this example embodiment is mounted on the electric power steering apparatus as the motor driving control unit, processing shown in FIG. 5 may be additionally performed after the above-described FET failure diagnosis.

After failure determination in the FET in each of steps S51, S53, S55, and S57 of FIG. 3, the controller 30 stores a failure determination result in the memory 25 in step S61 of FIG. 5. Then, in step S63, a warning display in accordance with the failure determination result in each of above steps S51, S53, S55, and S57 is performed.

As the warning display, display providing a notification that a failure is occurring in a switching device (FET) in the inverter circuit of the electronic control unit by the lighting, flashing, and the like of a lamp provided on a panel of the vehicle, for example, is conceived.

In step S65, the controller 30 determines whether it is the first time that the FET to be detected has been determined to be in the failure state. When the determination is the first failure determination, it is determined whether the failure diagnosis has been finished for all the phases in step S67. When the failure diagnosis for all the phases has not been finished, the processing is returned to step S11 of FIG. 3.

Meanwhile, when the failure diagnosis processing has been finished for all the phases, the controller 30 determines whether the failure is a failure (single fault) in only the FET in one phase and is the OFF failure of the FET in step S69. When the failure is a failure in only one phase and is the OFF failure, the assistance for the steering wheel of the electric power steering apparatus on which the inverter circuit (motor driving circuit) is mounted is continued (step S73).

As a result, assistance by degraded motor driving by two phases is can be continued, and the assistance of the steering wheel operation for the driver of the vehicle can be continued. At this time, although not shown in FIG. 2, it is also possible to separate only the phase exhibiting an abnormality by turning OFF a phase relay exhibiting the abnormality.

When a failure is determined for the FET to be detected a plurality of times (twice or more) in step S65, when it is determined that the failure in the FET is not a failure in only one phase in step S69, or when the failure is the ON failure of the FET even when the failure is a failure in only one phase, the controller 30 stops the assistance for the steering wheel in step S71. As a result, danger due to the FET being burned down and the like and significant deterioration of the assistance function can be prevented when a failure is determined a plurality of times, for example.

When it is diagnosed that all the FETs are normal for all the phases, that is, the U-phase, the V-phase, and the W-phase (steps S37 and S39), or when the failure in only one phase continues after the failure diagnosis of the FETs for all the phases in step S67 and assistance continuation processing is performed in step S73, the controller 30 determines whether the number of times of the failure diagnosis for all the phases is equal to or more than a predetermined number of times (n times) in step S75.

As described above, by performing the failure determination for the FETs in all the phases a plurality of times, reliable failure determination processing can be continuously executed for the FETs serving as power devices for a predetermined processing time period (for example, several tens of milliseconds), and a failure determination result with higher accuracy can be acquired.

For example, by limiting n times of the determination in the failure diagnosis to once or several times in step S75 in FIG. 5 instead of the configuration performing the failure diagnosis the plurality of times in the predetermined processing time, a configuration in which an initial failure in a motor control apparatus for electric power steering is responded to by diagnosing whether there is an initial failure in the inverter circuit when the ECU is starting up (the beginning of the driving of the motor) can be realized.

In addition, by a configuration in which n times of the failure diagnosis in step S75 is not limited and it is constantly diagnosed whether there is a failure in the FET of the inverter circuit, the failure in the motor control apparatus for electric power steering can be constantly (that is, continuously after the motor is driven) responded to while the ECU is executing the control and not only at the time of starting up the ECU.

In the motor control apparatus for electric power steering, the motor driving according to the degree of the failure of the FET and the assistance function according to the degree of the failure of the FET can be provided by a configuration in which the assistance is stopped or continued according to an occurrence time of the FET failure of the inverter circuit.

As described above, the electronic control unit according to this example embodiment compares the motor terminal (MV terminal) voltage corresponding to each phase of the inverter circuit composed of the plurality of semiconductor switching devices (FETs) for driving the motor with the threshold voltage by the comparators (voltage comparison circuitry). At the same time, a configuration is provided in which the threshold voltage is changed according to the high-side FET and the low-side FET to be subjected to the failure diagnosis, and it is monitored whether the MV terminal voltage value is normal or abnormal by the digital output (binary digital signal) from the comparator to determine the ON failure state and the OFF failure state of the FET.

As described above, since the controller determines whether there is a failure in each of the plurality of FETs based on the digital output value from the comparator, analog/digital signal conversion becomes unnecessary and signal response delay is eliminated, so that a waiting time for avoiding erroneous determination becomes unnecessary. As a result, whether there is a failure in the FET of the inverter circuit is quickly diagnosed and a time required for the failure diagnosis can be reduced.

Since the voltage to be measured (MV terminal voltage) is input into the comparator as voltage comparison circuitry and whether there is a failure in the driving device is determined based on the digital output value from the comparator, the number of parts for eliminating noise, for example, in the voltage to be measured in a conventional signal circuit can be reduced.

By providing a variable function of the reference voltage corresponding to the determination of whether there is an abnormality in the high-side FET and the low-side FET, a reliable abnormality determination is executable for each FET, and the faulted FET becomes to be easily identified.

Not only the ON failure of the FET but also the OFF failure is easily determined together with identification of the faulted FET. At this time, since a driving pulse generation circuit for the failure diagnosis becomes unnecessary, a circuit configuration in the failure determination is simplified, the number of parts of the electronic control unit can be reduced, and a substrate area can be reduced.

In addition, in the electric power steering apparatus, by including the motor control apparatus for electric power steering having the failure diagnosis function for the short circuit and the like of the FETs of the inverter circuit described above, it can be determined whether there is a failure in the motor driving power device with a simple configuration in an electric power steering system. As a result, the start-up time of the motor control apparatus for electric power steering can be reduced, and the time period until the steering assistance starts can be reduced.

When the abnormality of the power device is detected during the steering assistance, the failure can be determined (defined) in a short amount of time. Therefore, the time period in which the steering assistance is suspended can be reduced when it is determined that there is no failure.

### MODIFIED EXAMPLE

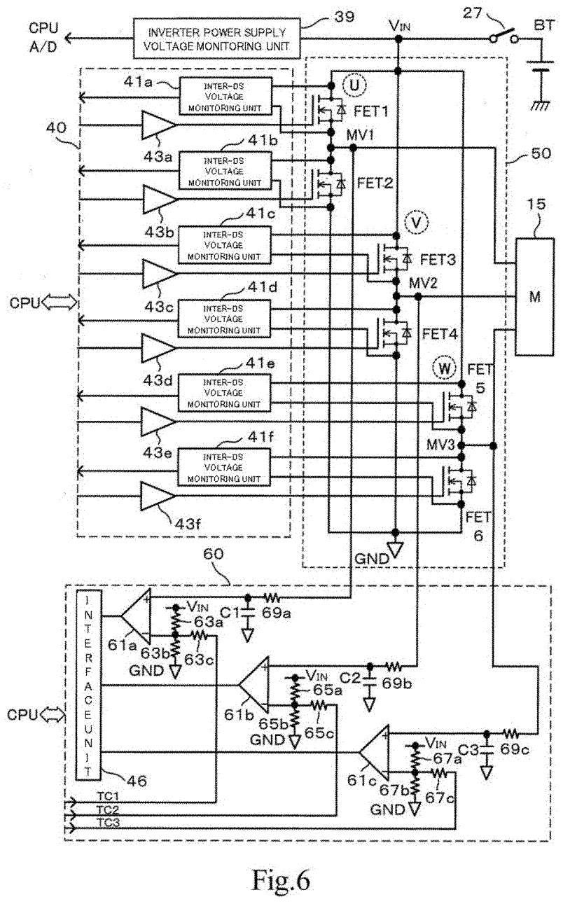

The present disclosure is not limited to the above example embodiment, and various modifications can be performed. For example, in addition to the configuration for comparing the motor terminal (MV terminal) voltage by the comparator, as shown in FIG. 6, a configuration may be provided in which an inverter power supply voltage monitoring unit 39 for monitoring the inverter power supply voltage V_{IN} is provided, so that the power supply voltage supplied from the battery BT to the motor driving portion 50 is monitored, and inter-DS voltage monitoring units 41a to 41f for monitoring a voltage between the drain terminal and the source terminal (between DS) of the respective FETs 1 to 6 are provided.

An A/D conversion unit built in the controller (not shown) converts a voltage monitoring result in the inverter power supply voltage monitoring unit 39 to a digital signal indicating an inverter power supply voltage value. The inter-DS voltage monitoring units 41a to 41f perform abnormality detection (abnormality monitoring) such as the short circuit of each of the FET1 to the FET6 by comparing the voltage between the drain terminal and the source terminal (between DS) of each FET with a predetermined threshold.

The on-resistance between the drain terminal and the source terminal of the FET is generally several milliohms. Therefore, if the D-S potential when the FET is driven to be turned ON is abnormally high, it can be determined that the FET is in a short-circuit failure state (ON failure) because a current that is equal to or higher than normal is flowing. In addition, the OFF failure means a state in which an energized state (ON state) is not obtained even when the FET is driven to be turned ON with application of an voltage equal to or higher than the gate threshold voltage.

For example, even though the FET in the OFF failure state is driven, the voltage between DS does not decrease. Thus, the inter-DS voltage monitoring unit of the pre-driver unit 40 detects the abnormality (OFF failure state) for the FET. At this time, the FET in which an abnormality is detected can be identified as the failure portion because the through current does not flow and the inverter power supply voltage does not decrease.

As described above, by combining monitoring of the motor terminal (MV terminal) voltage by the threshold in the MV terminal voltage monitoring unit 60, monitoring of the inverter power supply voltage in the pre-driver unit 40, and monitoring of the voltage between the drain terminal and the source terminal (between DS) of each of the FET1 to FET6 constituting the inverter circuit, the determination of the failure mode and the identification of the failure portion can be more precisely performed.

The setting of the threshold voltage in the MV terminal voltage monitoring unit 60 is not limited to the configuration described above. For example, the threshold voltage may be set in the comparator by individually outputting the threshold voltages TH1, TH2 from the two output ports of the controller corresponding to the determination of whether there is an abnormality in each of the high-side FET and the low-side FET.

A configuration can be provided in which, for example, the MV terminal voltage monitoring unit 60 is built in the pre-driver unit 40 instead of separately providing the pre-driver unit 40 and the MV terminal voltage monitoring unit 60 in the electronic control unit 20.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A failure diagnosis method for an inverter circuit including a plurality of high-potential-side driving devices and a plurality of low-potential-side driving devices, the failure diagnosis method comprising:
setting a reference voltage in voltage comparison circuitry;
driving each of the high-potential-side driving devices and each of the low-potential-side driving devices;
acquiring a comparison result between a voltage at a connection point of each of the high-potential-side driving devices and each of the low-potential-side driving devices after the driving and the reference voltage from the voltage comparison circuitry; and
determining whether there is a failure in each of the high-potential-side driving devices and each of the low-potential-side driving devices based on the comparison result.

2. The failure diagnosis method for an inverter circuit according to claim 1, wherein the reference voltage is changed corresponding to each of a failure determination of the high-potential-side driving devices and a failure determination of the low-potential-side driving devices in the setting step.

3. The failure diagnosis method for an inverter circuit according to claim 2, wherein the reference voltage is changed by inputting two different logical value signals into the voltage comparison circuitry.

4. The failure diagnosis method for an inverter circuit according to claim 1, wherein the comparison result is acquired as two different logical value signals.

5. The failure diagnosis method for an inverter circuit according to claim 1, wherein an ON failure and an OFF failure of each of the high-potential-side driving devices and the low-potential-side driving devices are determined in the determining step.

6. The failure diagnosis method for an inverter circuit according to claim 5, wherein the determination of whether there is a failure is performed a plurality of times in the determining step.

7. A circuit board to perform failure diagnosis of a high-potential-side driving device and a low-potential-side driving device of an inverter circuit, the circuit board comprising:
voltage comparison circuitry to compare a voltage to be measured from the inverter circuit and a reference voltage; and
a determiner to determine whether there is a failure in the high-potential-side driving device and the low-potential-side driving device based on an output from the voltage comparison circuitry by the failure diagnosis method according to claim 1.

8. A motor control apparatus including an inverter circuit to drive a motor, the motor control apparatus comprising:
voltage comparison circuitry to compare a voltage to be measured from the inverter circuit and a reference voltage; and
a determiner to determine whether there is a failure in a high-potential-side power device and a low-potential-side power device of the inverter circuit based on an output from the voltage comparison circuitry by the failure diagnosis method according to claim 1.

9. The motor control apparatus according to claim 8, wherein the voltage to be measured is a voltage at a connection point of the high-potential-side power device and the low-potential-side power device and is a terminal voltage of the motor.

10. The motor control apparatus according to claim 8, wherein
the motor has three phases; and
the determiner determines whether there is a failure in the high-potential-side power device and the low-potential-side power device for each phase of the three phases.

11. The motor control apparatus according to claim 8, wherein the high-potential-side power device and the low-potential-side power device define a bridge circuit that drives the motor in the inverter circuit.

12. A motor control apparatus for electric power steering to assist a steering wheel operation of a driver of a vehicle, the motor control apparatus comprising:
an inverter circuit to drive a motor;
voltage comparison circuitry to compare a voltage to be measured from the inverter circuit and a reference voltage; and
a determiner to determine whether there is a failure in a high-potential-side power device and a low-potential-side power device defining the inverter circuit based on an output from the voltage comparison circuitry by the failure diagnosis method according to claim 1.

13. The motor control apparatus according to claim 12, wherein the determiner determines whether there is a failure only during a start of driving of the motor.

14. The motor control apparatus according to claim 12, wherein the determiner continuously determines whether there is a failure after driving of the motor.

15. The motor control apparatus according to claim 13, wherein the assistance is determined to be stopped or continued in accordance with a period in which the failure occurs.

16. The motor control apparatus according to claim 12, wherein the high-potential-side power device and the low-potential-side power device define a bridge circuit that drives the motor in the inverter circuit.

17. An electric power steering system comprising the motor control apparatus according to claim 12.
